(19) United States
(12) Patent Application Publication
(10) Pub. No.: US 2016/0288130 A1
(43) Pub. Date: Oct. 6, 2016

(54) RADIAL FRAME FOR RECEIVING RADIAL GRINDING FORCES

(71) Applicant: TAKRAF GmbH, Leipzig (DE)

(72) Inventors: Meinhard FRANGENBERG, Kurten-Engeldorf (DE); Feleke TAMIRU, Koln (DE)

(73) Assignee: TAKRAF GmbH, Leipzig (DE)

(21) Appl. No.: 15/085,433

(22) Filed: Mar. 30, 2016

(30) Foreign Application Priority Data
Mar. 30, 2015 (DE) 10 2015 205 713.5

(51) Int. Cl. B02C 4/32; B02C 4/02

(52) U.S. Cl. CPC B02C 4/32; B02C 4/02

(57) ABSTRACT

The present invention relates to a radial frame as a radial force-receiving element of a machine frame of a two-roller press with a fixed roller and a loose roller, comprising two opposing side parts, each with a belt system with belts and box frame as a frame top part and as a frame bottom part, with vertical frame end pieces inserted left and right into the frame upper part and frame lower part which frame end pieces are constructed to be detachably fixed on the fixed roller side as replaceable end pieces and on the loose roller side with the same construction. The vertical frame end pieces are connected at their upper end to a rotary articulation and the particular double belts running in parallel comprise welded head connections at their ends on which head connections the vertical frame end pieces (vertical crossbeams) are supported.

### CROSS-REFERENCE TO RELATED APPLICATIONS

This application claims priority benefit under 35 U.S.C. §119 of German Patent Application No. 10 2015 205 713.5, filed Mar. 30, 2015, the entire contents of which are incorporated herein by reference.

### FIELD OF THE INVENTION

The present invention relates to a radial frame for receiving radial grinding forces, with one embodiment being a radial force-receiving element of a machine frame of a two-roller press having a fixed roller and a loose roller.

### BACKGROUND OF THE INVENTION

Roller presses are machines for comminuting a material bed with at least two rollers arranged in a machine frame. For the comminution of the material bed the particles are drawn into a roller gap, pressed against each other by the high pressure exerted by the rollers and comminute each other mutually. Roller presses are also designated as roller mills or roller mill presses and are used in the production of cement and in mining.

The machine frame must receive the high radial forces and, in addition, the occurring axial forces. Distortions are to be avoided in the machine frame since they result in a false position of the rollers and therefore in an inhomogeneous distribution of pressure with accompanying deterioration of the comminution result. The rollers are guided with their supports in the machine frame and held in position in the axial direction while a simultaneous oblique position is made possible and the possibility of a horizontal movement of the rollers and/or of their support in the frame. The loose roller has a distinctly greater freedom of movement here than the fixed roller on account of a support by hydraulic cylinders.

Usually, one of the rollers is constructed as a fixed roller and one as a loose roller. For maintenance and repair work it is regularly necessary to remove the rollers from the machine frame. For this, rapidly removable end pieces are frequently provided on at least one side of the frame by means of which the frame is to be opened on one side and the rollers can be removed in a horizontal direction.

Recent developments suggest constructing the machine frames of two-roller roller presses as a system of at least four individual frames. This contains at least two radial frames and at least one axial frame. The concepts axial frame and radial frame mean that the axial frames receive the axial forces of the rollers and the radial frames receive the radial forces of the rollers. Consequently, the radial frames are aligned at 90° to the axis of rotation of the rollers and the axial frames in the direction of the axes of rotation of the rollers. The individual frames are constructed rectangularly, that is, a level structure with four carrier-like frame elements. In the assembled state the planes formed by the individual frames are arranged at right angles crossed over each other and therefore form a parallelepiped.

The individual frames have longitudinal sides and short sides, wherein the longitudinal sides are arranged horizontally and the short sides vertically in the assembled state. In the radial frame the longitudinal sides are designated as belts, as the upper belt and the lower belt relative to the construction site.

In order to disassemble the rollers it is advantageous if they do not have to be lifted out of the machine frame but rather can be removed laterally. In this context DE 10 2010 015 374 A1 suggests providing U-shaped side frames closed by vertical frame pieces. These frame part pieces close the U shape and can be removed for disassembling the rollers. The forces created in the roller system must be transferred onto the frame. DE 10 2010 015 374 A1 suggests not connecting the frame part pieces rigidly to the shanks of the U-shaped side frame. This should make it possible for the frame part pieces to transfer the occurring forces via hammerhead-shaped closure elements provided to this end onto the machine frame. A disadvantage of the known construction is the fact that the frame part pieces must receive large forces.

Furthermore, in known constructions the connections between the end piece and the traction belt consist of several shear bolt screw connections. These connections require an expensive manufacture of structural parts which, however, can no longer be loosened after the roller press has been finished.

Therefore, DE 10 2010 048 214 A1 provides anchoring the vertical frame part pieces on the bottom end by safety bolts in the machine frame. For the upper end of the frame end pieces it is suggested that they be supported in a floating manner on the upper crossbeams of the U-shaped side frames. To this end a movable support with a spherical head receptacle for the vertical frame part pieces is arranged. A disadvantage of this construction is the fact that movable supports are subject to wear.

The present invention is directed to addressing these and other deficiencies in the art.

### SUMMARY OF THE INVENTION

One object of the present invention is to provide a radial frame construction which eliminates the disadvantages of the known construction of machine frames and which realizes an optimal construction.

The present invention solves various problems noted herein relating to the construction of machine frames known in the art, whereby the present invention provides a radial frame construction and advantageous embodiments thereof as described herein.

Therefore, in one aspect, the present invention relates to, inter alia, a radial frame for receiving radial grinding forces. In one embodiment, the present invention provides a radial force-receiving element of a machine frame of a two-roller press having a fixed roller and a loose roller.

In accordance with the present invention, the present disclosure provides a radial frame as a radial force-receiving element of the machine frame of a two-roller press with a fixed roller and a loose roller, comprising two opposing side parts, each with a belt system with belts and box frame as a frame top part and as a frame bottom part, with vertical frame end pieces inserted left and right into the frame upper part and frame lower part which frame end pieces are preferably constructed to be detachably fixed on the fixed roller side as replaceable end pieces and on the loose roller side with the same construction.

Various embodiments of the radial frame of the present invention are summarized below. For example, one embodiment of the radial frame of the present invention includes the following features: (i) the frame upper part and the frame lower part are constructed as double belts running in parallel; (ii) the vertical frame end pieces consist of crossbeams arranged in pairs, also called vertical crossbeams, which are connected on their upper end to a rotary articulation; (iii) which can oscillate independently from one another via individual crossbeams connected to a rotary shaft; (iv) the belts run through the two crossbeams of the vertical frame end pieces; (v) the rotary articulation arranged via a sphere between the lower guide pair is seated in a lower guide catch hook fastened on a shaft frame of the machine frame; (vi) the vertical crossbeams are arranged on their lower, appropriately formed end in devices that prevent a rotation of the vertical crossbeams about the vertical; (vii) the particular double belts running in parallel comprise welded head connections at their ends on which the vertical frame end pieces (vertical crossbeams) are supported; (viii) after the relaxing of the suspension point during the insertion procedure by the geometry of the rotary articulation, the vertical crossbeams are automatically placed on force receiving points of the belt system and during striking and raising the vertical crossbeams are automatically separated in the horizontal direction from the force receiving points; and (ix) the particular double belts running in parallel experience no additional loading from the weight forces from roller with support and the support of the vertical crossbeams.

In one embodiment, the radial frame of the present invention is characterized in that the vertical crossbeams are inserted into hollow spaces formed from the lower shaft frame, a closure part and the lower belts.

In another embodiment, the radial frame of the present invention is characterized in that the belts connected by the head connections comprise elastic damping elements on the ends directed away from the vertical frame part pieces which damping elements are pretensioned by the amount which results by calculation from the value for the belts, which lengthen in operation at nominal power.

In another embodiment, the radial frame of the present invention is characterized in that the belts are purely traction-loaded, the tractive force lies in the neutral phase and also remains over the length of the belts and the lengthenings from the symmetric elongation are received in the elastic damping elements.

In another embodiment, the radial frame of the present invention is characterized in that the head connections are constructed as hammerhead-like welded constructions.

In another embodiment, the radial frame of the present invention is characterized in that the head connections have the largest possible welding seam lengths on a very small space.

In another embodiment, the radial frame of the present invention is characterized in that the head connections comprise elastic damping elements on their ends directed away from the vertical frame end pieces.

In another embodiment, the radial frame of the present invention is characterized in that the elastic damping elements act to reduce jolts.

In another embodiment, the radial frame of the present invention is characterized in that the welded head connections comprise force receiving points on their ends directed away from the vertical frame part pieces.

In another embodiment, the radial frame of the present invention is characterized in that the belt systems are centered exactly in the machine frame by a central bolt in the middle of the machine lying on a horizontal line.

The construction in accordance with the present invention follows the solutions from the prior art and improves the execution and arrangement of the vertical frame part pieces and suggests a novel belt system which engages with the latter. In particular, reference is made to the two application cited in the discussion of the prior art and the general construction of the machine frame is also considered to be applicable to the present invention to the extent that no deviating disclosures take place.

These and other objects, features, and advantages of this invention will become apparent from the following detailed description of the various aspects of the invention taken in conjunction with the accompanying drawings.

### BRIEF DESCRIPTION OF THE DRAWINGS

For the purpose of illustrating aspects of the present invention, there are depicted in the drawings certain embodiments of the invention. However, the invention is not limited to the precise arrangements and instrumentalities of the embodiments depicted in the drawings. Further, if provided, like reference numerals contained in the drawings are meant to identify similar or identical elements.

FIG. 1 is an illustration of one embodiment of a vertical crossbeam pair in accordance with the present invention.

FIG. 2 is an illustration of another perspective of the vertical crossbeam pair illustrated in FIG. 1.

FIG. 3 is an illustration of the receiving of the lower end of one embodiment of a vertical crossbeam pair of the present invention in a lower box frame.

FIG. 4 is an illustration showing the construction of one embodiment of a radial frame of the present invention.

FIG. 5 is an illustration showing the construction on one embodiment of a head end of the upper box frame of the present invention.

FIG. 6 is an illustration showing one embodiment of the box frame of the present invention having a double belt as a belt system.

FIG. 7 is an illustration showing an enlarged view of the head end of one embodiment of the belt system of the present invention.

### DETAILED DESCRIPTION OF THE INVENTION

The present invention provides, inter alia, a radial frame construction which eliminates the disadvantages of the known construction of machine frames and which realizes an optimal construction.

Therefore, in one aspect, the present invention relates to, inter alia, a radial frame for receiving radial grinding forces. In one embodiment, the present invention provides a radial force-receiving element of a machine frame of a two-roller press having a fixed roller and a loose roller.

The vertical frame end pieces, also called vertical crossbeams, consist of two parallel, vertically arranged crossbeam-like side parts that are connected together on the upper end by the rotary shaft of a rotary articulation. The rotary articulation is preferably fastened by a rotary shaft with slide bearing and groove nuts. The rotary axis carries a suspension articulation between the two crossbeam-like side parts. The suspension articulation comprises a sphere (lower guide sphere) in the middle. A lower guide with a lower guide catch hook (lower guide-rapid coupler) is fastened on the axial frame. According to the invention the vertical crossbeam pair is suspended in the lower guide catch hook in a rotatable and pivotable manner with the lower guide sphere arranged centrally in the suspension articulation and is preferably appropriately secured at the top by a spring-loaded lock which can be locked at the end. As a result of the fact that these oscillating individual crossbeams (vertical crossbeams) are connected in such a manner by a rotary shaft and by the guide geometry, an automatic placing on the force-receiving points of the belt systems takes place when the latter are suspended in the lower guide catch hooks. The guide geometry changes the partial conversion of the vertically acting weight force into a horizontal force component. To this end the lower guide catch hook, fastened on the axial frame, comprises a recess complementary to the lower guide sphere. The lower guide sphere engages into this recess while preserving the degrees of freedom of the movement on the suspension articulation of the vertical crossbeams.

The lower end of the vertical frame end pieces is inserted into hollow spaces formed from the lower axial frame, a closure part and the lower belts. To this end the side parts preferably comprise insertion surfaces on their lower end, preferably on the sides directed away from the rotary articulation. These insertion surfaces facilitate the introduction of the side parts into the hollow spaces. They are preferably conically formed to this end and comprise gliding coatings (e.g., Teflon) in a preferred further development.

In a another preferred embodiment the vertical crossbeams are inserted in the lower area by their corresponding shapes into adjustable insertion surfaces, e.g., formed from disk pairs that are arranged in a comb shape on a shaft and which prevent a rotation of the vertical crossbeams about the vertical. This improves the operating safety against a tilting of the crossbeams out of the horizontal planes. The inner surfaces of the crossbeams therefore remain in operation parallel to the radial force plane (longitudinal direction of the belts).

The upper and lower belts are preferably constructed as double belts running parallel above one another which are connected at the head ends with special hammerhead-like welding constructions—the head connections. The belts run between the two side parts of the vertical frame part pieces which side parts run in parallel. The vertical crossbeams are supported in the direction of the radial force (radial force acts staggered 90° in comparison to the roller shafts) on the welded head connections of the double belts. On the ends directed away from the vertical frame part pieces the belts connected by the preferably welded head connections comprise an elastic damping element. The damping element of the double belts is pretensioned by the amount (path) from the longitudinal extension resulting from the longitudinal extension resulting from the operating force. Therefore, the elastic support of the belts is pretensioned by a defined path almost without load, i.e., relaxed during operation at nominal power.

Even the jolts occurring during operation are made less by the damping element. The box-shaped frame elements of the belt system are preferably constructed as structural components running in parallel between which the belts run. The box frame is closed around the double belts by the screwed head parts with the required adjustment gap into which the vertical frame part pieces (vertical crossbeams) are inserted. The elastic damping elements of the belt system are pretensioned by the screwed head parts on the two ends of the associated box frame, preferably consisting of steel profiles. Upon the occurrence of radial forces the vertical crossbeams receive them and pass them via the welded head connection to the double belts. The latter are elongated, wherein the elongation movement of the belts is caught in the elastic dampening elements. In an especially advantageous manner the elastic damping elements are pretensioned by the amount which results by calculation from the value for the belts, which lengthen in operation at nominal power. As a result, the elastic damping elements are almost relieved in the operating state. The pretension of the elastic damping elements is produced in the direction of the radial force in that a defined adjustment gap between the box frame and the head plate becomes zero by tightening the fastening screws of the head plates. This adjustment gap can be adjusted by adding or removing distancing sheets.

The present invention provides numerous advantages over the prior art. Various of these advantages are described below with respect to certain aspects or embodiments of the present invention.

In certain embodiments of the present invention, the belts as traction rods are purely traction-loaded by the radial grinding forces and achieve a symmetrical expansion that considers the structural part. Therefore, this allows for the following: (i) no additional forces from weight forces from roller with support; (ii) no additional forces from vertical operating forces from roller with support; and (iii) no influencing of the expansion by additionally welded-on frame reinforcements and arrangements.

In certain embodiments, the present invention involves minimizing the influences by the radial operating forces on the axial frame. The elastic damping elements reduce jolts in the frame from the operation. The longitudinal changes of the belts and the resulting forces on the box frame are eliminated by the elastic damping elements.

In one aspect, the present invention provides a reduction of the sizes of the structural parts with advantages achieved by this including for the transport, for the manufacture, and for the manufacturing site.

In another aspect, the present invention provides significant weight reduction and associated cost reduction from lighter belt cross-sections. The belts, which are no longer weakened by the shear bolt openings and screw passage holes, can be reduced in their sickness by one half the cross-sections of the shear bolts.

In another aspect, the present invention provides economical, simple manufacture of the belt system by minimizing the machining work. The belt systems do not assume any weight forces, and therefore do not have any sliding elements as a result of which they do not have to be worked over their length. A shear bolt screw connection is eliminated.

In another aspect of the present invention, the belt systems and their structural parts such as, e.g., the belts in “double construction,” can be readily replaced in the case of damage.

In another aspect, the present invention provides uniformity of structural parts: (i) frame structural part also as replacement part; (ii) structural box over the roller press series; and (iii) upper frame belt and lower frame belt are structurally the same.

The design according to the invention of vertical frame and pieces (vertical crossbeams) achieves the following advantages as described below.

In one aspect, the present invention provides rotary shaft connection instead of a welding connection. This results in simple and economical manufacture. Further, it requires no expensive welding construction of the closure element in “tuning-fork shape” so as to avoid the following disadvantages found in the prior art: (i) the great distortion and tensions that can occur due to the size of the welded part and of the welding heat that is to be partially introduced; (ii) the expense for preheating the structural component before the welding; or (iii) the alignment work necessary to keep the working additions small.

In another aspect, the present invention can be practiced without screw connection to the frame in the lower area of the vertical frame part pieces. This results in shortening of the assembly and disassembly times.

In another aspect of the present invention, the crossbeams of the vertical frame end pieces (vertical crossbeams) can move independently of each other by the rotary shaft connection and can therefore be optimally placed on the force receiving points of the belt systems and their extensions.

In another aspect, the present invention provides for simple assembly and disassembly. For example, no additional fastening screws are required by the present invention.

In another aspect, the present invention requires no shifting elements on the frame structural components loading the tractive force and as a result also no elements subject to wear such as the sliding pairing of Teflon/polished chromium sheet.

In another aspect, the present invention provides automatic placing when suspending on the force receiving points on the belt systems.

In another aspect of the present invention, the vertical crossbeam suspension is fastened of the shaft frame. The weight does not act on the traction-loaded belts of the radial frame

In another aspect of the present invention, the vertical crossbeams are inserted in a preferred embodiment in the lower area with their slopes between two belts on parallel shafts that can be adjusted in width and which prevent a rotation of the vertical crossbeam about a vertical line. This improved embodiment makes possible a safe operation without tilting of the crossbeams out of the horizontal planes, i.e., the inner surfaces of the crossbeams remain parallel to the plane of radial force (longitudinal direction of the belts) during operation.

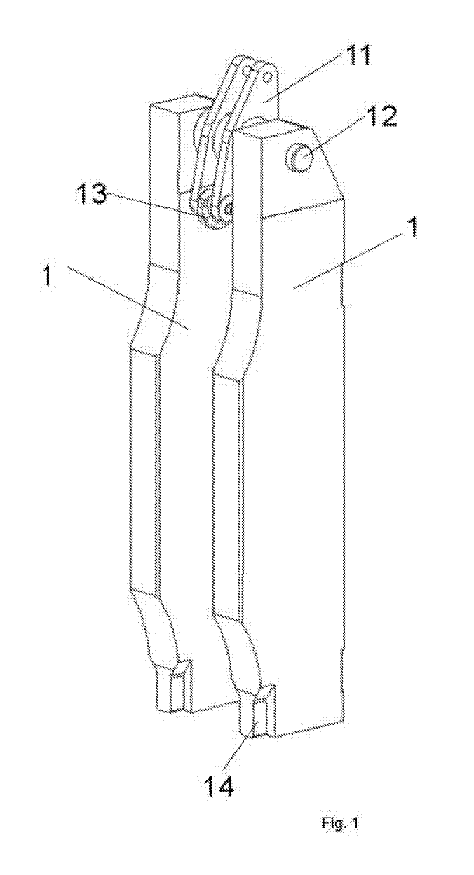

Referring to the drawings, various aspects of the present invention are illustrated in the embodiments shown in FIGS. 1-6. In referring to the drawings, various reference numerals are used, as set forth in Table 1 below.

TABLE 1
List of Reference Numerals Used in the Drawings

| Reference Numeral | Description of Element |
|---|---|
| 1 | vertical crossbeam |
| 2 | lower box frame |
| 3 | upper box frame |
| 11 | rotary articulation |
| 12 | rotary shaft without groove nuts |
| 13 | catch hooks |
| 14 | insertion surface |
| 21 | lower double belt |
| 22 | head end of the lower belt |
| 23 | disk pair |
| 31 | upper double belt |
| 32 | head end double belt |
| 321 | bolt with safety sheet |
| 322 | head plate with welded-on receptacle 323 |
| 323 | receptacle of the head plate, in which the |
| | damping element is seated |
| 3221 | fastening screws of the head plate |

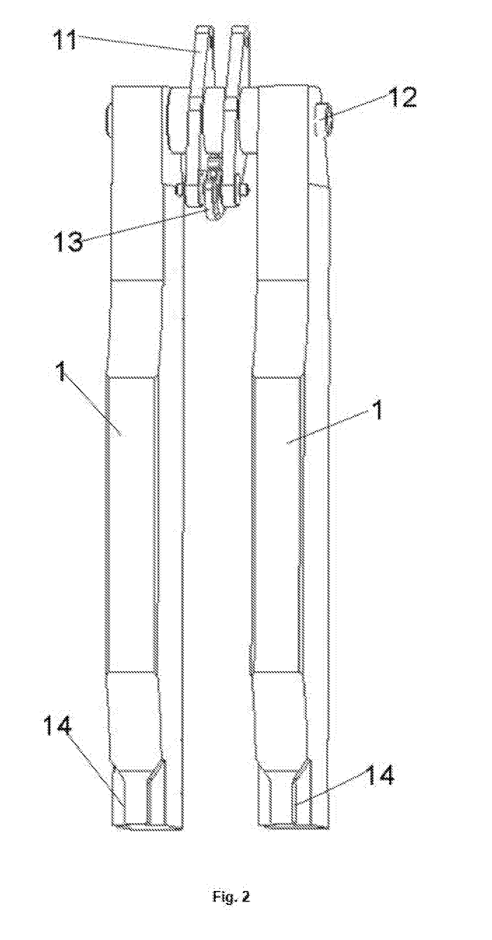

FIG. 1 and FIG. 2 are different perspective views of one embodiment of a vertical crossbeam pair 1 with a rotary articulation 11 that is arranged in the vicinity of the upper end of the vertical crossbeams 1. The rotary articulation 11 can rotate about the axis of rotation (e.g., rotary shaft without groove nuts 12) and is seated above a sphere arranged between the lower guide pair of the rotary articulation 11 in a catch hook 13 which for its part is fastened to the shaft frame (not shown here). The vertical crossbeam 1 is inserted into the lower box frame by the insertion surfaces 14 for better guidance and is fixed there.

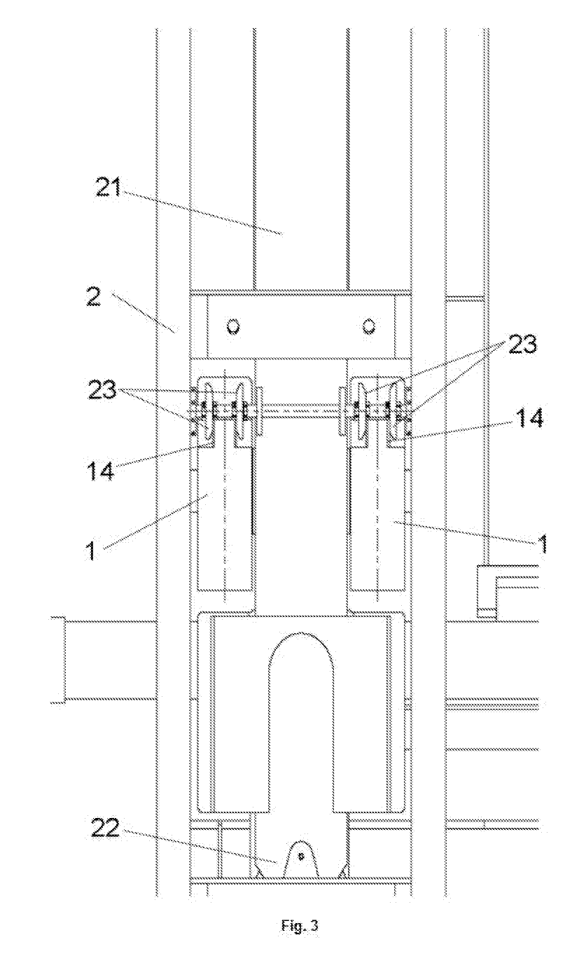

FIG. 3 is an illustration of the receiving of the lower end of one embodiment of a vertical crossbeam pair 1 of the present invention in a lower box frame 2. As shown, the disk pairs 23 prevent a rotation of the vertical crossbeams 1 about the vertical. This improves operating safety against a tilting of the vertical crossbeams 1 out of the horizontal planes. FIG. 3 also illustrates the insertion surfaces 14, lower double belt 21, and head end of the lower belt 22 as arranged with respect to the vertical crossbeam pair 1 and lower box frame 2.

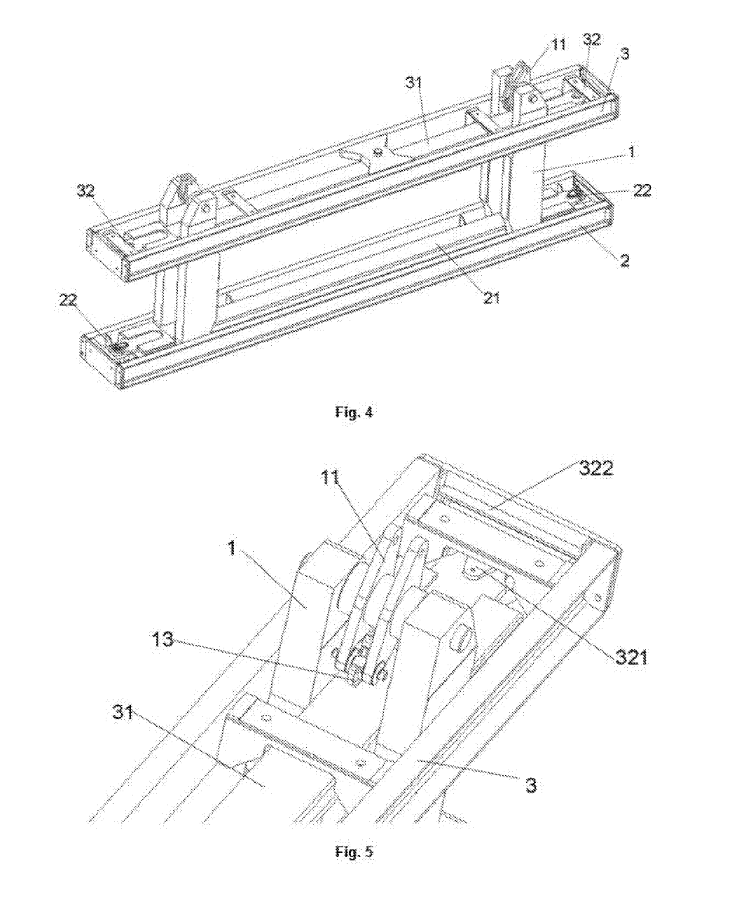

FIG. 4 is an illustration showing the construction of one embodiment of a radial frame of the present invention. As shown, a lower belt system (e.g., lower box frame 2) and an upper belt system (e.g., upper box frame 3) form with the inserted vertical crossbeam pairs 1 a closed force system. These vertical crossbeam pairs 1 rest on the force receiving points of the lower belts 21 or of the upper belts 31 in a movable manner with all required degrees of freedom. FIG. 4 also illustrates the rotary articulation 11, head end of the lower belt 22, and the head end double belt 32 as arranged with respect to the vertical crossbeam pair 1 and lower box frame 2.

FIG. 5 is an illustration showing the construction on one embodiment of a head end of the upper box frame 3 of the present invention. The catch hook 13 is screwed onto the shaft frame (not shown here). FIG. 5 also illustrates vertical crossbeam 1, rotary articulation 11, upper double belt 31, bolt with safety sheet 321, and head plate 322 as arranged with respect to the vertical crossbeam pair 1 and upper box frame 3.

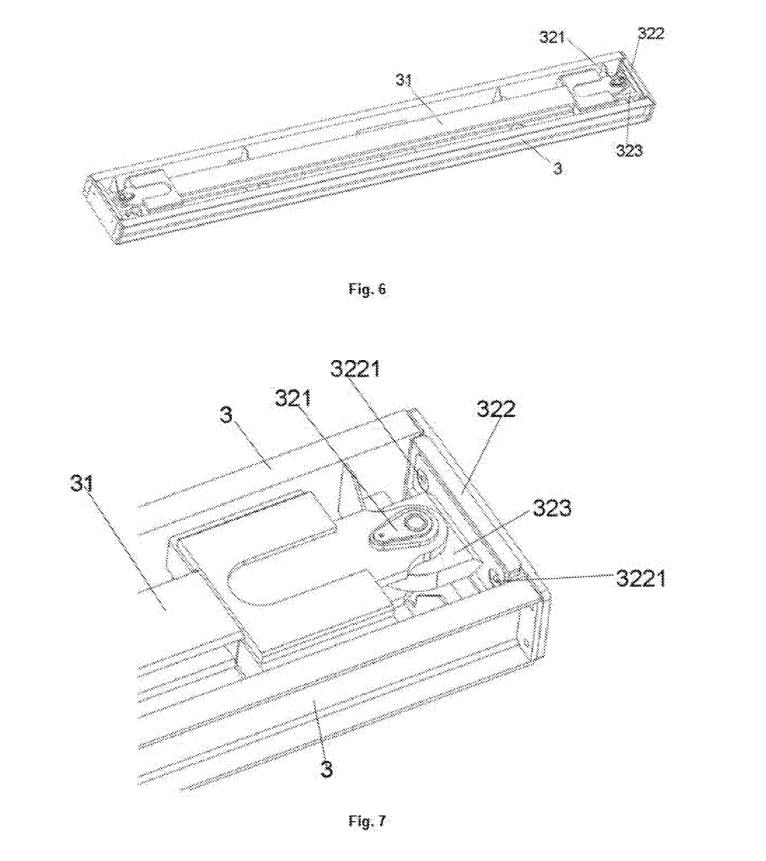

FIG. 6 is an illustration showing one embodiment of box frame 3 of the present invention having a double belt as a belt system (e.g., upper double belt 31). The head plate 322 and the steel part (e.g., receptacle 323 of head plate 322) welded to it are on the head end of the double belt (e.g., upper double belt 31), wherein the damping element is shown seated, as well as the connection elements for these structural components, that are constructed as bolts with a safety sheet 321.

FIG. 7 is an illustration showing an enlarged view of the head end of one embodiment of the belt system of the present invention. In addition to the elements shown in FIG. 6, the holes for the fastening screws 3221 of the head plate 322 can be recognized. FIG. 7 also illustrates upper double belt 31, bolt with safety sheet 321, and receptacle 323 of head plate 322, as arranged with respect to upper box frame 3.

As set forth herein, embodiments of the present invention discussed herein have been described by way of example in this specification. Having thus described the basic concept of the invention, it will be rather apparent to those of ordinary skill in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the invention. Additionally, the recited order of processing elements or sequences, or the use of numbers, letters, or other designations therefore, is not intended to limit the claimed processes to any order, except as may be specified in the claims. Accordingly, the invention is limited only by the following claims and equivalents thereto.

What is claimed is:

1. A radial frame as a radial force-receiving element of a machine frame of a two-roller press with a fixed roller and a loose roller, comprising two opposing side parts, each with a belt system with belts and box frame as a frame top part and as a frame bottom part, with vertical frame end pieces inserted left and right into the frame upper part and frame lower part which frame end pieces are preferably constructed to be detachably fixed on the fixed roller side as replaceable end pieces and on the loose roller side with the same construction.

2. The radial frame according to claim 1, wherein the frame upper part and the frame lower part are constructed as double belts running in parallel, wherein the vertical frame end pieces consist of crossbeams arranged in pairs, also called vertical crossbeams, which are connected on their upper end to a rotary articulation, which can oscillate independently from one another via individual crossbeams connected to a rotary shaft, wherein the belts run through the two crossbeams of the vertical frame end pieces, wherein the rotary articulation arranged via a sphere between the lower guide pair is seated in a lower guide catch hook fastened on a shaft frame of the machine frame, wherein the vertical crossbeams are arranged on their lower, appropriately formed end in devices that prevent a rotation of the vertical crossbeams about the vertical, wherein the particular double belts running in parallel comprise welded head connections at their ends on which the vertical frame end pieces (vertical crossbeams) are supported, after the relaxing of the suspension point during the insertion procedure by the geometry of the rotary articulation, the vertical crossbeams are automatically placed on force receiving points of the belt system and during striking and raising the vertical crossbeams are automatically separated in the horizontal direction from the force receiving points, and wherein the particular double belts running in parallel experience no additional loading from the weight forces from roller with support and the support of the vertical crossbeams.

3. The radial frame according to claim 2, wherein the vertical crossbeams are inserted into hollow spaces formed from the lower shaft frame, a closure part and the lower belts.

4. The radial frame according to claim 2, wherein the belts connected by the head connections comprise elastic damping elements on the ends directed away from the vertical frame part pieces which damping elements are pretensioned by the amount which results by calculation from the value for the belts, which lengthen in operation at nominal power.

5. The radial frame according to claim 2, wherein the belts are purely traction-loaded, the tractive force lies in the neutral phase and also remains over the length of the belts and the lengthenings from the symmetric elongation are received in the elastic damping elements.

6. The radial frame according to claim 2, wherein the head connections are constructed as hammerhead-like welded constructions.

7. The radial frame according to claim 2, wherein the head connections have the largest possible welding seam lengths on a very small space.

8. The radial frame according to claim 2, wherein the head connections comprise elastic damping elements on their ends directed away from the vertical frame end pieces.

9. The radial frame according to claim 2, wherein the elastic damping elements act to reduce jolts.

10. The radial frame according to claim 2, wherein the welded head connections comprise force receiving points on their ends directed away from the vertical frame part pieces.

11. The radial frame according to claim 2, wherein the belt systems are centered exactly in the machine frame by a central bolt in the middle of the machine lying on a horizontal line.
